(19) United States
(12) Patent Application Publication
(10) Pub. No.: US 2009/0252306 A1
(43) Pub. Date: Oct. 8, 2009

(54) TELEMEDICINE SYSTEM AND METHOD

(75) Inventors: David James Bates, Waukesha, WI (US); David Wayne Duckert, Menomonee Falls, WI (US)

Correspondence Address: Andrus, Sceales, Starke & Sawall, LLP, 100 East Wisconsin Avenue, Suite 1100, Milwaukee, WI, 53202-4178, US

(73) Assignee: THE GENERAL ELECTRIC COMPANY, Schenectady, NY (US)

(21) Appl. No.: 12/098,730

(22) Filed: Apr. 7, 2008

(51) Int. Cl. H04M 11/00

(52) U.S. Cl. 379/88.18

(57) ABSTRACT

The telemedicine system and method includes an ubiquitous telephone and interactive voice response (IVR) system configured to interface with a hub, and in some embodiments, with medical sensor devices directly. The system and method allows an interested party to interface with the hub using a telephone. The system and method eliminates a user interface from the hub, and optionally includes a separate server.

### FIELD OF THE DISCLOSURE

The present disclosure relates to the field of chronic disease monitoring. More particularly, the present disclosure relates to the field of telemedicine systems and methods.

### BACKGROUND OF THE DISCLOSURE

Telemedicine is a rapidly evolving area. Referring to FIG. 1, there are many systems 10 being proposed to capture physiological data from medical sensor devices 20 and transmit that data back to a central server 30 for review by caseworkers and clinicians. Most of these systems 10 leverage consumer-off-the-shelf medical sensor devices 20 to capture the readings. These devices, including blood pressure monitors, glucometer, weight scales, etc., are typically available from drug and department stores. The data from these sensor devices 20 is often transmitted to a hub 40 for consolidation and then forwarded to the central server 30.

The communication method used between the sensor devices 20 and the hub 40 is often Universal Serial Bus (USB) 50 or wireless Bluetooth (BT) 60. The communication means 70 used between the hub 40 and the central server 30 can be broadband, telephone modem or cellular. Typically, the sensor devices 20 and the hub 40 are both located in the non-clinical environment 80, while the server 30 is located in a clinical environment 90 such as a hospital clinic, lab, etc.

Some methods promote the cellular telephone as a hub 40. Other methods require a dedicated tabletop box, or a television in conjunction with a set-top box for the hub 40. Typically, data is collected on a daily basis and sent to the central server 30 for review by a caseworker or clinician.

One patient population that benefits from telemedicine is the chronically ill patient population. These patients are typically elderly and often suffer from reduced vision, dexterity and cognitive capacity. Furthermore, these patients are often not comfortable with new technologies, such as cell phones and other electronic gadgets. However, most of these patients are comfortable using a conventional telephone.

Because the system 10 described above relies on a cellular telephone or some other electronic device (tabletop box, etc.) to the hub 40, the target population is likely to experience difficulty using the interfaces on these devices. Small buttons, complex user interfaces, and tiny displays will exceed many patients' abilities. Moreover, having the user interfaces directly on the hub 40 increases the size of the hub 40 and manufacturing costs.

Also, persons who have an interest in the health of the patient such as clinicians, caseworkers, family members, relatives, neighbors, etc., may want to receive periodical updates of the patient's status and be notified if and when there is a problem. With the conventional system 10, this can typically be done only by directly contacting the patient, either by stopping by the patient in person or by calling the patient on the telephone, or, if they have sufficient authorizations, by accessing the patient's information on the central server 30 or by speaking with medical personnel at the clinical environment 90. These methods may be impractical, however, especially if the interested person is on a different schedule than the patient or if the interested person does not have access to a web browser.

Furthermore, the medical sensor devices 20 typically are consumer-off-the-shelf products and have their own user interfaces. For example, if the patient has a blood pressure monitoring device, that device would likely have start/stop buttons and a screen for reporting the values and error conditions. Similarly, the patient's glucometer (from another vendor) may have a different user interface. The weight scale would include yet another unique user interface. The target population is likely to be confused by this plethora of user interfaces. They may be required to interact with the cellular telephone or tabletop box one minute: “ . . . time for your blood pressure reading, place the cuff over your left arm . . . ,” and then be required to interact with the blood pressure monitor device the next minute.

Lastly, the conventional system 10 relies on a central server 30 to store the data and to convey it to interested parties. A central server 30 requires some supporting infrastructure and must be purchased and maintained. Furthermore, the central server 30 may not be cost effective for managing a small population of patients.

### SUMMARY OF THE DISCLOSURE

The telemedicine system and method includes an ubiquitous telephone and interactive voice response (IVR) system configured to interface with a hub, and in some embodiments, with medical sensor devices directly. The system and method allows an interested party to interface with the hub using a telephone. The system and method eliminates a user interface from the hub, and optionally includes a separate server.

One aspect of the present invention is a system for collecting physiological data from a remote patient and retrieving the physiological data, the system comprises a hub in wireless communication with a medical sensor device, the hub including a data repository system and an interactive voice response (IVR) system; and a first telephone in communication with the IVR system of the hub, such that a patient receives a set of instructions from the IVR through the first telephone, wherein the set of instructions prompt the user to self administer the collection of a set of physiological data with the medical sensor device and requires the patient to confirm each of a plurality of steps in the set of instructions with a user interface of the first telephone.

Another aspect of the present invention is a system for collecting physiological data from a remote patient and retrieving the physiological data, the system comprises a hub in wireless communication with a medical sensor device, the hub including a first interactive voice response (IVR) system; a service in wireless communication with the hub, the server including a second IVR and a data repository system; and a first telephone in communication with the IVR system of the hub, such that a patient receives a set of instructions from the IVR through the first telephone, wherein the set of instructions prompt the user to self administer the collection of a set of physiological data with the medical sensor device and requires the patient to confirm each of a plurality of steps in the set of instructions with a user interface of the first telephone.

### BRIEF DESCRIPTION OF THE DRAWINGS

FIG. 1 is a graphical representation of a prior art telemedicine system.

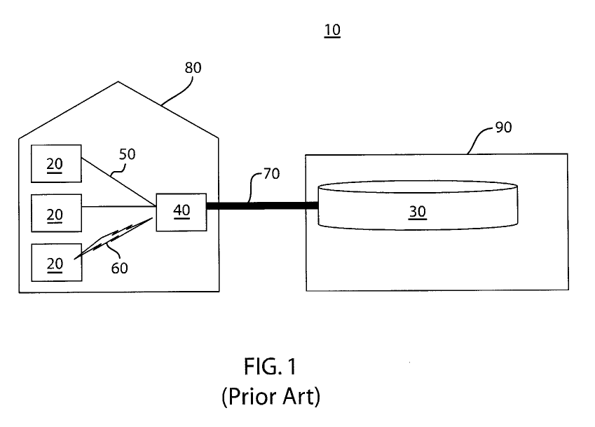

FIG. 2 is a graphical representation of one embodiment of the system of the present disclosure.

FIG. 3 is a graphical representation of another embodiment of the system of the present disclosure.

FIG. 4 is a flow chart of one embodiment of the method of the present disclosure.

### DETAILED DESCRIPTION

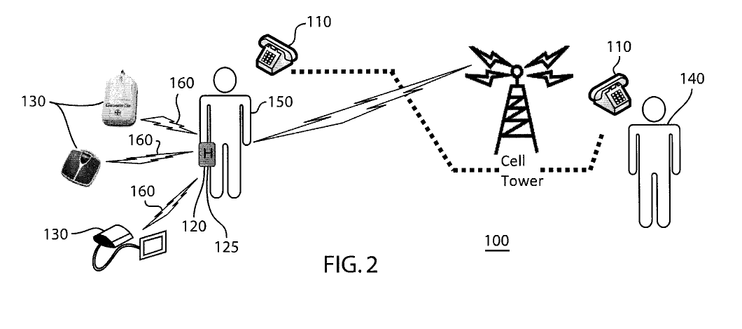

An embodiment of the telemedicine system 100 of the present application is illustrated in FIG. 2. The system 100 utilizes a telephone 110 and interactive voice response (IVR) 125 system to interface with the hub 120, and in some embodiments, with the medical sensor devices 130 as well. IVR 125 is a phone technology that allows a computer to detect voice and/or touch tones using conventional telephones. The IVR 125 system can respond with pre-recorded or dynamically generated audio to further direct callers on how to proceed. IVR 125 systems can be used to control almost any function where the interface can be broken down into a series of simple menu choices. This system works well for an elderly target population because they are already comfortable using conventional telephones and IVR 125 systems. Additionally, interested persons 140, for example relatives or clinicians who live remote from the patients 150, can directly interface with the hub 120 using the IVR 125 system and telephones 110 (conventional or cell) to learn the patient's 150 status without having to directly contact or disturb the patient 150. Moreover, the hub 120 can be made smaller and at lower cost because the user interface (e.g., keyboard and screen) is eliminated.

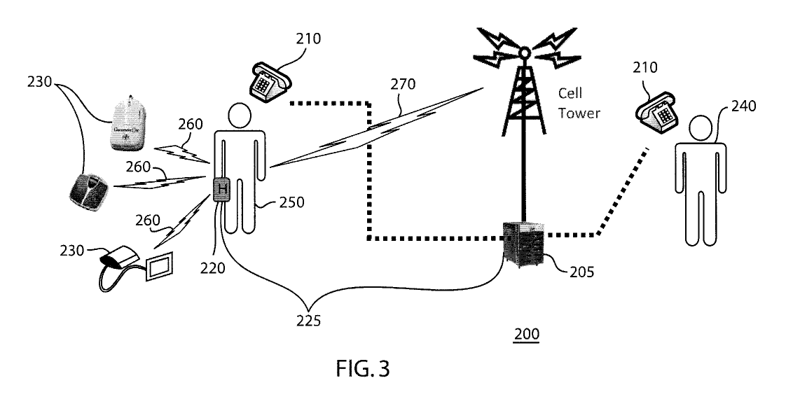

The telemedicine system 100 may be implemented with or without a central server 205. The telemedicine system 200 embodiment in FIG. 3 implements such a central server 205, while the telemedicine system 100 of FIG. 2 does not. Given the low cost of non-volatile memory, the hub 120 may store all the data on-board and make it available via an IVR 125 interface through the telephone. This eliminates the need to purchase and maintain a separate server in the system 100 embodiment of FIG. 2. Furthermore, the system 100 would more readily scale to support small patient populations. Alternatively, or in addition as shown in FIG. 3, the hub 220 could forward the data to the central server 205 at the time of receipt (substantially real-time) or in batch mode (e.g., daily) for storage and processing.

In FIG. 2, the hub 120 is a “blind” cellular communication device that includes an on-board data repository and IVR 125 system. The hub 120 has a phone number assigned to it by a wireless provider. The patient 150 and/or interested persons 140 can call the hub's 120 phone number using a conventional telephone 110 or cell phone to query the data in the hub 120 using the on-board IVR 125 system. The patient 150 and/or interested person 140 can also call the hub 120 to configure or program it using the IVR 125. In any case, the IVR 125 system may be equipped with a security identification system such that levels of access to data and/or configuration abilities may be established for the patient 150 and interested persons 140. It is obvious that a doctor should have configuration abilities while a relative or friend of the patient should have more limited “read-only” access/abilities. Moreover, the hub 120 can also call the patient 150 and/or interested person 140 for various reasons such as explained below.

In the case of FIG. 3, the hub 220 is again a “blind” cellular communication device that includes an on-board IVR 225 system but no long-term data repository. Instead, the hub 220 forwards the data to a central server 205 that stores the data long term and which also includes an IVR 225 system. The patient 250 and/or interested person 240 can call the central server 205 using a conventional telephone 210 or cell phone to query the data using the IVR 225. The patient 250 and/or interested person can also call the hub 220 to program or configure the hub 220 using the on-board IVR 225. The hub 220 can call the patient 250 and/or interested person 240 for various reasons such as explained below.

Referring again to FIG. 2, the hub 120 receives data from the medical sensor devices 130 via a wireless interface 160 such as, but not limited to Bluetooth, and/or a wired interface (not shown) that is plugged in when needed. The hub 120 can also issue commands to the medical sensor devices 130 such as inflate cuff, initiate measurement, re-try measurement, etc., although the hub 120 in a preferred embodiment is “blind”, in that it lacks substantial interface functionality such as a display screen or input buttons, it may include rudimentary status indicators such as a battery power indicator (e.g., 4-bar display), a cellular signal strength indicator (e.g., 4-bar display), a problem status indicator (e.g., red LED for problem-state or green for all-good), a charging indicator light, etc. The “blind” hub 120 may also include a power (i.e., on-off) button. The hub 120 may be patient 150 worn or simply a small portable device designed to sit on a table or mount to a wall.

The medical sensor devices 130 that send data to the hub 120 may also be “blind,” in that they may have no display or input buttons. In such cases, the sensor devices 130 could be controlled by the hub 120 via the wireless interface 160 or wired interface.

Still referring to FIG. 2 above, the hub 120 stores the sensor data that it receives from the medical devices 130. It may also store other data collected by other means such as self-assessment data collected via the telephone 110 IVR 125 interface. As noted above, the hub 120 also includes an IVR 125 system to allow it to be queried by an interested party 140 using a conventional or wireless telephone 110. In addition, the IVR 125 system will deliver instructions, educational materials and coaching to the patient 150 via the IVR 125 system over a conventional or wireless telephone 110. In summary, the data resides in the hub 120 and queries are served by an IVR 125 system that also resides in the hub 120.

Referring now to FIG. 3, the hub 220 forwards the data it receives from the sensor devices 230 through the wireless interface 260 (or alternate wired connections) to the central server 205 via cellular communication 270. The central server 205 serves several functions in this embodiment. First, it serves as the long-term repository for all the data collected by the medical sensor devices 230. It also stores other data collected by other means, again through self-assessment data collected via the telephone 210. Second, the central server 205 will control an IVR 225 that can deliver instructions, educational materials and coaching to the patient 250 via a conventional or wireless telephone 210. Alternatively, or in addition, the hub 220 may have an on-board IVR 225 for interacting with the patient 250 and for being programmed or configured. In summary, the data resides in the central server 205 and is served via an IVR 225 system that may also reside in the central server 205.

In both embodiments described above, the user interfaces traditionally provided on such hubs 120, 220 are rendered superfluous (and thus can be eliminated) through use of cellular communication capabilities and an on-board or readily available IVR 125, 225 system. Thus, the ubiquitous telephone 110, 210 essentially becomes the main user interface for the hubs 120, 220. In one embodiment shown in FIG. 2, the cellular hub 120 stores the data and hosts an IVR system to serve it to interested parties 140. In another embodiment shown in FIG. 3, a central server stores the data and hosts an IVR 225 system to serve it to interested parties 240.

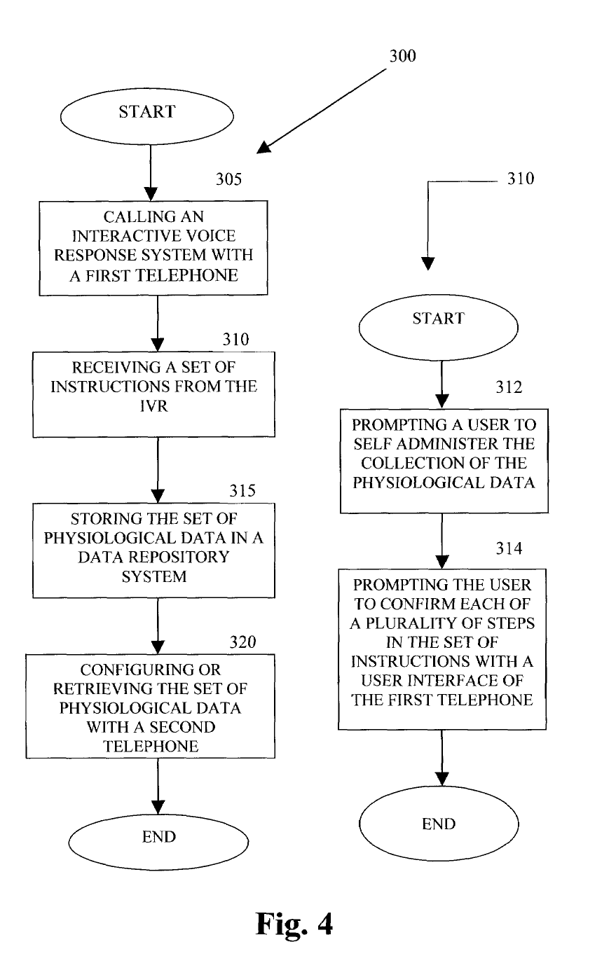

Referring now to FIG. 4, a method 300 of one embodiment of the present application is depicted in flow chart form. While the steps of the method 300 are described herein and depicted in the flow chart of FIG. 4, it is to be understood that the method 300 utilizes the components of the system described above. In step 305, a remote patient calls an interactive voice response system with a first telephone. In step 310, the user receives a set of instructions from the IVR, wherein the instructions prompt a user to self administer the collection of the physiological data in step 312 and further prompts the user to confirm each of a plurality of steps and the set of instructions with the user interface of the first telephone in a step 314. In step 315, the physiological data is stored in the data repository system configured in the hub as described above. Lastly, in step 320, the physiological data may be configured or retrieved with a second telephone as described above with respect to the system of the present application.

The following examples are intended to illustrate the embodiments of the present application in use. While the examples are given to illustrate a patient utilizing each of the embodiments of the present application, they are not intended to limit those embodiments to the facts and circumstances of the particular example.

### Example #1

John Doe is 79 years old and suffers from stage 3 congestive heart failure. To manage his illness better, he needs to provide his clinician with daily measurements of his weight and blood pressure. The clinician can then use this data to better titrate John's medication. John also has poor vision and some arthritis in his hands. John is not technologically savvy. At home, John has a wireless weight scale and a wireless blood pressure monitor. He also has a small hub device, which he keeps in his pocket. Every morning John gets a telephone call from an IVR 125, 225 system. The IVR 125, 225 system is resident on the small hub device, but may also reside on the central server (if one exists), or on some other system. The call comes in on John's wall phone, a device that he is comfortable using. When John answers the phone, the IVR 125, 225 system states: “Good morning John. You need to take your blood pressure reading today. Please place the blood pressure cuff on your arm. If you need more detailed instructions on how to apply the cuff, press or say 1. If you don't have your cuff or it is not working, press or say 2. If the cuff is on your arm now, press or say 3.”

After John applies the cuff he presses “3”. Referring to FIGS. 2 and 3, if the IVR 125, 225 system is remote from the hub 120, 220, the IVR system sends a command to the hub device 120, 220. The command is “Initiate blood pressure measurement”. The hub 120, 220 receives the command and forwards it on to the blood pressure monitor device 130, 230 over the wireless interface 160, 260. If the IVR 125, 225 system is on the hub 120, 220 the hub 120, 220 directly commands the blood pressure monitor 130, 230 to initiate the pressure reading. In either case, the blood pressure monitor 130, 230 receives the command and initiates a measurement. The data from the measurement is sent to the hub 120, 220 and then either forwarded on to the central server 205, or the hub 120, 220 may store the measurement in a database in local memory along with other related information such as a timestamp reflecting when the patient was prompted to take the reading and when the patient actually took the reading. The hub 120, 220 may store all patient data received over a set period of time (e.g., the prior week, month or year), all data until memory is full (in which case old data could be overwritten), or no data storage at all (other than a temporary queue for data transmission purposes). In any case, the IVR 125, 225 system then reports the value to John over the wall telephone, using an easily understandable spoken message such as “Your blood pressure is 1-3-4 over 9-8. Press or say 1 if you want to continue, or press or say 2 if you'd like to hear the value again.” John presses “1”.

The IVR 125, 225 system then says “your blood pressure is higher than yesterday—have you taken your medication recently? Press or say 1 if you have been taking your medication, press or say 2 if you forgot to take your medication recently, press or say 3 if you are out of pills, or press or say 4 to continue”. John presses “4”. The IVR 125, 225 system responds “You need to check your weight today,” and John is instructed to weigh himself and send that information much like what was described above with respect to the blood pressure measurement.

Interested persons (e.g., relatives, physicians or clinicians) are able to call the hub 120, 220 via the IVR 125, 225 system to confirm that John has taken his blood pressure readings and, if not, to have the IVR 125, 225 system call John and repeat the message that he needs to have his pressure read. The interested persons can also directly find out John's pressure readings from one or more prior measurements.

The method and system is configured such that, John doesn't need to deal with a variety of complex and different user interfaces. Referring to FIGS. 2 and 3, he only interfaces with a standard telephone 110, 210. Also, interested persons can interact with the hub 120, 220 and medical sensor devices 130, 230 via the IVR system in the same way as John.

### Example #2

Next week John plans to travel to his daughter's house for several days. In his bag he packs his devices 130, 230 (blood pressure monitor, weight scale and hub). When he arrives he calls the phone number printed on the hub. The IVR 125, 225 system responds: “Hello, you are calling in from a location other than your home, please enter your home telephone number.” John does this and the IVR 125, 225 system recognizes him “Hello John Doe of 1234 Elm Street, if you are not John Doe of 1234 Elm Street press or say 1, if you are John Doe of 1234 Elm Street press or say 2 to continue.” John presses 2. “Good afternoon John, press or say 1 if you'd like us to call you at this number tomorrow. Press or say 2 if you like us to call you at your home number tomorrow.” Since John plans to stay several days, he presses 1. The IVR 125, 225 system stores the caller ID number for use tomorrow and responds “You need to check your weight today.”

In another embodiment, the IVR 225 system is also the mechanism for clinicians and non-clinical caregivers to interact with the central server 205 (FIG. 3) and manage the patient's 250 condition. For example, the IVR 225 system contacts the clinician 240 when some intervention is required.

### Example #3

“Hello Dr. Smith, your patient, John Doe, has not taken his blood pressure measurement in −6-days”; or “Hello Nurse Wilson, your patient, John Doe, has indicated that his supply of medication has run out”; or “You've selected patient John Doe, press or say 1 to hear last measured blood pressure value, press or say 2 to hear dry weight, press or say 3 to hear last reported weight, etc.”

The system and method of the present disclosure also includes further embodiments implementing the following features:

Referring to FIGS. 2 and 3, the hub 120, 220 device may include a personal emergency response button (PERS). Known as PERS (not shown), this functionality summons police or ambulance if pressed. Furthermore, the hub 120, 220 device may include a global positioning system receiver (GPS) (not shown) to transmit the position of the hub 120, 220 when the button is pressed.

The hub 120, 220 device may also operate in a “store and forward” mode. If the measurement process is simple and becomes routine, no user interface may be required for some measurements, for example measuring one's blood sugar. In this case, the patient 150, 250 may take measurements asynchronously without prompting from the IVR 125, 225 system. Since the telephone 110, 210 user interface is not required in this scenario, these measurements could be captured at anytime, even while the patient 150, 250 is in transit and/or out of cellular coverage. In this case, the hub 120, 220 stores the value internally and forwards it on to the central server 205 when cellular coverage becomes available again.

In a further embodiment, if the hub 120, 220 device is worn by the patient 150, 250, the hub 120, 220 device could include an accelerometer, which could provide additional data about the patient's 150, 250 condition such as activity level, exercise levels, stability, etc.

In a further embodiment, with sufficient memory, the hub 120, 220 device becomes the server for long-term data storage, eliminating the need for a central server 205. In this embodiment, clinicians 140, 240 would contact the hub 120, 220 directly over the cellular Interface 170, 270, leveraging the IVR 125, 225 system to interact with the hub 120, 220 device to determine the patient's 150, 250 condition.

The present invention has been described in terms of specific embodiments incorporating details to facilitate the understanding of the principals of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. A system for collecting physiological data from a remote patient and retrieving the physiological data, the system comprising:
a hub in wireless communication with a medical sensor device, the hub including a data repository system and an interactive voice response (IVR) system; and
a first telephone in communication with the IVR system of the hub, such that a patient receives a set of instructions from the IVR through the first telephone, wherein the set of instructions prompt the user to self administer the collection of a set of physiological data with the medical sensor device and requires the patient to confirm each of a plurality of steps in the set of instructions with a user interface of the first telephone.

2. The system as claimed in claim 1, wherein the hub is configured to transmit a command to the medical sensor device, wherein the command prompts the medical sensor device to start or stop collecting the set of physiological data from the patient.

3. The system as claimed in claim 1, wherein the medical sensor device is configured to transmit the set of physiological data to the hub after collecting the set of physiological data form the patient.

4. The system as claimed in claim 3, wherein the set of physiological data is stored in the hub.

5. The system as claimed in claim 4, further comprising a second telephone in communication with the IVR system of the hub, wherein an interested person can access and configure the IVR and the set of physiological data in the hub through the second phone.

6. The system as claimed in claim 5, wherein the IVR system is configured to contact the interested person through the second phone.

7. The system as claimed in claim 1, wherein the hub does not include a user interface.

8. The system as claimed in claim 1, wherein the medical sensor device does not include a user interface.

9. The system as claimed in claim 1, wherein the hub further includes a set of educational materials accessible by the patient through the first phone.

10. The system as claimed in claim 1, where the IVR includes a configurable security system.

11. The system as claimed in claim 1, wherein the hub includes a personal emergency response button.

12. The system as claimed in claim 1, wherein the hub includes a global positioning system receiver.

13. A system for collecting physiological data from a remote patient and retrieving the physiological data, the system comprising:
a hub in wireless communication with a medical sensor device;
a central server in wireless communication with the hub;
an interactive voice response (IVR) system located in at least one of the hub and the central server; and
a first telephone in communication with the IVR system, such that a patient receives a set of instructions from the IVR through the first telephone, wherein the set of instructions prompt the user to self administer the collection of a set of physiological data with the medical sensor device and requires the patient to confirm each of a plurality of steps in the set of instructions with a user interface of the first telephone.

14. The system as claimed in claim 13, wherein the hub is configured to transmit a command to the medical sensor device, wherein the command prompts the medical sensor device to start or stop collecting the set of physiological data from the patient.

15. The system as claimed in claim 13, wherein the medical sensor device is configured to transmit the set of physiological data to the hub after collecting the set of physiological data form the patient.

16. The system as claimed in claim 15, wherein the set of physiological data is transferred and stored in the data repository system of the server.

17. The system as claimed in claim 15, further comprising a second telephone in communication with the second IVR system of the server, wherein an interested person can access and configure the second IVR and the set of physiological data in the server through the second phone.

18. The system as claimed in claim 17, wherein the second IVR system is configured to contact the interested person through the second phone.

19. The system as claimed in claim 13, wherein the hub does not include a user interface.

20. The system as claimed in claim 13, wherein the medical sensor device does not include a user interface.

21. The system as claimed in claim 13, wherein the hub further includes a set of educational materials accessible by the patient through the first phone.

22. The system as claimed in claim 13, wherein the second IVR includes a configurable security system to all varying levels of access to the set of physiological data.

23. The system as claimed in claim 13, wherein the hub includes a person emergency response button.

24. The system as claimed in claim 13, wherein the hub includes a global positioning system receiver.

25. The system as claimed in claim 13, wherein the IVR system is located in the hub.

26. The system as claimed in claim 13, wherein the IVR system is located in the central server.

27. The system as claimed in claim 13, wherein the IVR system is located in both the hub and the central server.

28. A method of collecting physiological data from a remote patient and retrieving the physiological data, the method comprising:
calling an interactive voice response (IVR) system with a first telephone, wherein the IVR is located in a hub;
receiving a set of instructions from the IVR through the first telephone, wherein the set of instructions include the further method steps of:
prompting a user to self administer the collection of a set of physiological data with a medical sensor device, wherein the medical sensor device is in wireless communication with the hub; and
prompting the user to confirm each of a plurality of steps in the set of instructions with a user interface of the first telephone; and
storing the set of physiological data in a data repository system, wherein the data repository system is located in the hub.

29. The method as claimed in claim 28, further comprising transmitting a command to the medical sensor device with the hub, wherein the command prompts the medical sensor device to start or stop collecting the set of physiological data from the patient.

30. The method as claimed in claim 28, further comprising transmitting the set of physiological data to the hub with the medical sensor device after collecting the set of physiological data form the patient.

31. The method as claimed in claim 29, further comprising storing the set of physiological data in the hub.

32. The method as claimed in claim 31, wherein a second telephone is in communication with the IVR system of the hub, and further comprising an interested person accessing and configuring the IVR and the set of physiological data in the hub through the second phone.

33. The method as claimed in claim 32, further comprising the IVR system contacting the interested person through the second phone.

34. The method as claimed in claim 28, wherein the hub does not include a user interface.

35. The method as claimed in claim 28, wherein the medical sensor device does not include a user interface.

36. The method as claimed in claim 28, wherein the hub further includes a set of educational materials accessible by the patient through the first phone.

37. The method as claimed in claim 28, wherein the IVR includes a configurable security system.

38. The method as claimed in claim 28, wherein the hub includes a personal emergency response button.

39. The method as claimed in claim 28, wherein the hub includes a global positioning system receiver.
